(19) United States
(12) Patent Application Publication
(10) Pub. No.: US 2026/0131668 A1
(43) Pub. Date: May 14, 2026

(54) APPARATUS AND METHOD FOR CONTROLLING SMART REGENERATIVE BRAKING BASED ON YAW RATE

(71) Applicants: Hyundai Motor Company, Seoul (KR); Kia Corporation, Seoul (KR)

(72) Inventors: Han Seon GA, Hwaseong-Si (KR); Ho Young LEE, Hwaseong-Si (KR); Jin Seok SONG, Hwaseong-Si (KR); Kweon Soo JEON, Hwaseong-Si (KR); Sang Wook HAN, Hwaseong-Si (KR)

(73) Assignees: Hyundai Motor Company, Seoul (KR); Kia Corporation, Seoul (KR)

(21) Appl. No.: 19/178,465

(22) Filed: Apr. 14, 2025

(30) Foreign Application Priority Data
Nov. 13, 2024 (KR) 10-2024-0160736

(51) Int. Cl. B60L 15/20; B60L 7/18

(52) U.S. Cl. CPC B60L 15/2036; B60L 7/18; B60L 2240/14; B60L 2240/22; B60L 2240/423

(57) ABSTRACT

An apparatus for controlling smart regenerative braking based on yaw rate includes a processor; a sensor electrically connected to the processor; an input/output interface electrically connected to the processor; and a memory connected to the processor and storing instructions, wherein, when an instruction stored in the memory is executed by the processor, the processor performs a vehicle state determination logic configured to determine a map information reception state and a vehicle steering state, the processor performs a target deceleration setting logic configured to obtain a first target deceleration based on a distance between vehicles or a second target deceleration, and the processor performs a target torque setting logic configured to determine a smaller value between the first target deceleration and the second target deceleration and set the smaller value as target deceleration, and determining target torque for regenerative braking.

### CROSS-REFERENCE TO RELATED APPLICATION(S)

The present application claims priority to Korean Patent Application No. 10-2024-0160736 filed on Nov. 13, 2024, the entire contents of which is incorporated herein for all purposes by this reference.

### BACKGROUND OF THE PRESENT DISCLOSURE

### Field of the Present Disclosure

The present disclosure relates to an apparatus and a method for controlling smart regenerative braking based on yaw rate.

### Description of Related Art

In general, regenerative braking technology may be of recovering energy generated from a motor and applying energy to braking force by turning a motor rotor with rotation force of wheels due to inertia when an accelerator pedal is turned off during vehicle deceleration.

Also, smart regenerative braking (smart regeneration braking) may be a braking method for controlling deceleration of the vehicle by automatically adjusting regenerative braking force in accordance with driving conditions of the vehicle when an accelerator pedal is released differently from general regenerative braking not considering a driving condition of the vehicle. In the instant case, the driving condition may be based on inter-vehicle distance information, or speed limit information from a speed camera.

General smart regenerative braking may generate a target motor torque for deceleration by setting final target deceleration using inter-vehicle distance, target deceleration, and navigation map information.

However, general smart regenerative braking method may not consider vehicle driving conditions such as understeering or oversteering when setting the target deceleration, and especially, vehicle driving conditions may not be applied to target deceleration setting or motor torque distribution so that regenerative braking may be performed only based on the inter-vehicle distance information. Accordingly, unnecessary frequent deceleration changes may occur due to unnecessary acceleration and deceleration driving by a driver, and frequent load transfer caused by such deceleration changes may have a negative effect on driving stability.

When a driver preemptively may reduce the speed more than necessary, deceleration may be performed excessively, and a driver may intervene again and may operate the pedal in the acceleration direction. Accordingly, due to driving in which acceleration and braking are frequently repeated, fuel efficiency may deteriorate.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and method for controlling smart regenerative braking based on yaw rate which may, by reflecting a driving condition of a vehicle based on yaw rate and navigation information into target deceleration setting and torque distribution strategy, prevent unnecessary deceleration, and reduce unnecessary driver intervention so that vehicle driving stability may be improved.

According to an aspect of the present disclosure, an apparatus for controlling smart regenerative braking based on yaw rate includes a processor; a sensor electrically connected to the processor; an input/output interface electrically connected to the processor; and a memory connected to the processor and storing instructions, wherein, when an instruction stored in the memory is executed by the processor, the processor is configured to perform a vehicle state determination logic configured to determine a map information reception state and a vehicle steering state based on vehicle driving information and a yaw rate measurement value obtained through the sensor and the input/output interface, the processor is configured to perform a target deceleration setting logic configured to obtain a first target deceleration based on a distance between vehicles or a second target deceleration based on map information using at least one of the map information, the vehicle driving information, and the yaw rate measurement value depending on whether the map information is receivable, and the processor is configured to perform a target torque setting logic configured to determine a smaller value between the first target deceleration and the second target deceleration and set the smaller value as target deceleration, and determining target torque for regenerative braking based on the target deceleration.

The apparatus may further include a torque distribution logic configured to distribute the target torque to front and rear wheels to correct a vehicle steering state based on the vehicle steering state.

The vehicle state determination logic may include a map information reception state determination portion configured to determine whether the entirety of a first condition of whether a current braking mode is a smart regenerative braking mode and whether an accelerator pedal is in a turned-off state, a second condition of whether a current travelling road is a curved road, and a third condition of whether the map information is receivable are satisfied based on the vehicle driving information; a target yaw rate generation portion configured to generate a yaw rate target value based on the yaw rate measurement value; and a vehicle steering state determination portion configured to determine whether the vehicle steering state is an understeering state or an oversteering state based on a yaw rate error value between the yaw rate measurement value and the yaw rate target value.
the vehicle steering state determination portion include a yaw rate error value calculation portion configured to obtain the yaw rate error value by subtracting the yaw rate target value from the yaw rate measurement value; and a steering state determination portion configured to determine a state as understeering when the yaw rate error value is negative, and to determine a state as oversteering when the yaw rate error value is positive.

The target deceleration setting logic includes a first target deceleration setting portion configured to adjust an initial target deceleration based on the yaw rate error value and to obtain the first target deceleration when the map information is unreceivable; and a second target deceleration setting portion configured to adjust the initial target deceleration based on a radius of curvature, driving mode, wiper operation information and yaw rate error value included in the map information and to obtain the second target deceleration when the map information is receivable.

The second target deceleration setting portion is configured to adjust the second target deceleration by reflecting the road-surface state information when road-surface state information is included in the vehicle driving information.

The second target deceleration setting portion includes a road-surface friction coefficient setting portion configured to set different initial road-surface friction coefficients in accordance with a driving mode included in the vehicle driving information, and to obtain a final road-surface friction coefficient by applying a first weighting factor in accordance with a wiper operation state to an initial road-surface friction coefficient; a maximum speed setting portion configured to determine an initial maximum speed using the final road-surface friction coefficient, a radius of curvature included in the map information, and gravitational acceleration, and to determine a final maximum speed by applying a second weighting factor based on the yaw rate error value to the initial maximum speed; and a target deceleration obtaining portion configured to obtain the second target deceleration based on the final maximum speed and measured current speed.

The second target deceleration setting portion includes a maximum speed setting portion configured to obtain an initial maximum speed using an initial road-surface friction coefficient, the radius of curvature included in the map information, and gravitational acceleration, and to obtain a final maximum speed by applying a second weighting factor based on the yaw rate error value to the initial maximum speed; a target deceleration obtaining portion configured to obtain the second target deceleration based on the final maximum speed and measured current speed; and a target deceleration adjustment portion configured to adjust the second target deceleration using the yaw rate error value.

The target torque setting logic sets the target torque to be distributed more to front wheels than to rear wheels by a set ratio when the vehicle steering state is an oversteering state, and sets the target torque to be distributed more to the rear wheels than to the front wheels by a set ratio when the vehicle steering state is an understeering state.

The apparatus may further include a torque distribution logic configured to distribute motor torque to front and rear wheels in accordance with the torque distribution setting when the current vehicle driving information of a vehicle is in 4-wheel driving mode, and suggests changing to or engagement in 4WD driving mode for front/rear motor torque distribution when the current vehicle is in 2WD driving mode.

According to an aspect of the present disclosure, a method for controlling smart regenerative braking control based on yaw rate includes a vehicle state determination operation of determining a map information reception state and a vehicle steering state based on vehicle driving information and a yaw rate measurement value obtained through a sensor and an input/output interface; a target deceleration setting operation of obtaining and setting a first target deceleration based on a distance between vehicles or a second target deceleration based on map information using at least one of the map information, vehicle driving information, and yaw rate measurement value depending on whether the map information is receivable; and a target torque setting operation of determining a smaller value among the first target deceleration and the second target deceleration as target deceleration, and obtaining and setting a target torque for regenerative braking based on the target deceleration.

The method may further include a torque distribution operation configured to distribute the target torque to front and rear wheels to correct a vehicle steering state based on the vehicle steering state.

The vehicle state determination operation may include a map information reception state determination operation of determining whether the entirety of the first condition of whether a current braking mode is a smart regenerative braking mode and whether an accelerator pedal is in a turned-off state, a second condition of whether a current travelling road is a curved road, and a third condition of whether the map information is receivable are satisfied based on the vehicle driving information; a target yaw rate generation operation of generating a yaw rate target value based on the yaw rate measurement value; and a vehicle steering state determination operation of determining whether a vehicle steering state is an understeering state or an oversteering state based on a yaw rate error value between the yaw rate measurement value and the yaw rate target value.

The vehicle steering state determination operation may include a yaw rate error value determination operation of obtaining a yaw rate error value by subtracting the yaw rate target value from the yaw rate measurement value; and a steering state determination operation of determining understeering when the yaw rate error value is negative, and determining oversteering when the yaw rate error value is positive.

The target deceleration setting operation may include a first target deceleration setting operation of obtaining and setting first target deceleration by adjusting initial target deceleration based on the yaw rate error value when the map information is unreceivable; a second target deceleration setting operation of obtaining and setting second target deceleration by adjusting the initial target deceleration based on a radius of curvature, driving mode, wiper operation information and yaw rate error value included in the map information when the map information is receivable.

The second target deceleration setting operation may include adjusting the second target deceleration by reflecting road-surface state information when the road-surface state information is included in the vehicle driving information.

The second target deceleration setting operation may include a road-surface friction coefficient setting operation of setting different initial road-surface friction coefficients in accordance with a driving mode included in the vehicle driving information, and obtaining a final road-surface friction coefficient by applying a first weighting factor in accordance with a wiper operation state to an initial road-surface friction coefficient; a maximum speed setting operation of determining an initial maximum speed using the final road-surface friction coefficient, a radius of curvature included in the map information, and gravitational acceleration, and determining a final maximum speed by applying a second weighting factor based on the yaw rate error value to the initial maximum speed; and a target deceleration obtain operation of obtaining the second target deceleration based on the final maximum speed and measured current speed.

The second target deceleration setting operation may include a maximum speed setting operation of determining an initial maximum speed using an initial road-surface friction coefficient, the radius of curvature included in the map information, and gravitational acceleration, and determining a final maximum speed by applying a second weighting factor based on the yaw rate error value to the initial maximum speed; a target deceleration obtain operation of obtaining the second target deceleration based on the final maximum speed and measured current speed; and a target deceleration adjust operation of adjusting the second target deceleration using the yaw rate error value.

The target torque setting operation may include setting the target torque to be distributed more to front wheels than to rear wheels by a set ratio when the vehicle steering state is an oversteering state, and setting the target torque to be distributed more to the rear wheels than to the front wheels by a set ratio when the vehicle steering state is an understeering state.

The torque distribution operation may include distributing motor torque to front and rear wheels in accordance with the torque distribution setting when current vehicle driving of the vehicle driving information is in 4-wheel driving mode, and suggesting changing to or engagement in 4WD driving mode for front/rear motor torque distribution when current vehicle driving is in 2-wheel driving mode.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a diagram illustrating an apparatus for controlling smart regenerative braking according to an exemplary embodiment of the present disclosure.

FIG. 2 is a diagram illustrating a configuration of logic performed in the processor according to an exemplary embodiment of the present disclosure.

FIG. 3A is a diagram illustrating an understeering state and an oversteering state of a vehicle according to an exemplary embodiment of the present disclosure.

FIG. 3B is a diagram illustrating torque distribution for understeering control and oversteering control according to an exemplary embodiment of the present disclosure.

FIG. 4 is a diagram illustrating a configuration of vehicle state determination logic according to an exemplary embodiment of the present disclosure.

FIG. 5 is a diagram illustrating a configuration of vehicle steering state determination portion according to an exemplary embodiment of the present disclosure.

FIG. 6 is a diagram illustrating a configuration of target deceleration setting logic according to an exemplary embodiment of the present disclosure.

FIG. 7 is a diagram illustrating a second target deceleration setting portion according to an exemplary embodiment of the present disclosure.

FIG. 8 is a diagram illustrating a configuration of a second target deceleration setting portion according to an exemplary embodiment of the present disclosure.

FIG. 9 is a diagram illustrating a configuration of a second target deceleration setting portion according to an exemplary embodiment of the present disclosure.

FIG. 10 is a diagram illustrating a configuration of a second target deceleration setting portion according to an exemplary embodiment of the present disclosure.

FIG. 11A is a diagram illustrating torque distribution in the case of in the case of oversteering O_ST according to an exemplary embodiment of the present disclosure.

FIG. 11B is a diagram illustrating torque distribution in the case of understeering U_ST according to an exemplary embodiment of the present disclosure.

FIG. 12 is a diagram illustrating a torque distribution logic according to an exemplary embodiment of the present disclosure.

FIG. 13 is a flowchart illustrating a method for controlling smart regenerative braking control according to an exemplary embodiment of the present disclosure.

FIG. 14 is a diagram illustrating a torque distribution operation according to an exemplary embodiment of the present disclosure.

FIG. 15 is a diagram illustrating a vehicle state determination operation according to an exemplary embodiment of the present disclosure.

FIG. 16 is a diagram illustrating a configuration of a vehicle steering state determination operation according to an exemplary embodiment of the present disclosure.

FIG. 17 is a diagram illustrating a configuration of a target deceleration setting operation according to an exemplary embodiment of the present disclosure.

FIG. 18 is a diagram illustrating a second target deceleration setting operation according to an exemplary embodiment of the present disclosure.

FIG. 19 is a diagram illustrating a configuration of a second target deceleration setting operation according to an exemplary embodiment of the present disclosure.

FIG. 20 is a diagram illustrating a configuration of a second target deceleration setting operation according to an exemplary embodiment of the present disclosure.

FIG. 21 is a diagram illustrating a torque distribution operation according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the FIGURES, reference numbers refer to the same or equivalent portions of the present disclosure throughout the several FIGURES of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, specific embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the exemplary embodiments of the present disclosure, when it is determined that a detailed description of a known technology related to the present disclosure may unnecessarily obscure the gist of the present disclosure, the detailed description thereof will be omitted. Also, terms to be described below are terms defined in consideration of functions in the present disclosure, which may vary depending on intention or the custom of a user or operator. Accordingly, the definition of these terms should be made based on the contents throughout the present specification. The terminology used herein is for describing various exemplary embodiments only and is not to be limiting of the embodiments. As used herein, the singular forms “a,” “an,” and “the” are intended to include the plural forms as well, unless the context clearly indicates otherwise. As used herein, the term “and/or” includes one and any combination of any two or more of the associated listed items. It will be further understood that the terms “comprises” and/or “comprising,” when used in the present specification, specify the presence of stated features, integers, steps, operations, elements, components or a combination thereof, but do not preclude the presence or addition of one or more other features, integers, steps, operations, elements, components, and/or groups thereof.

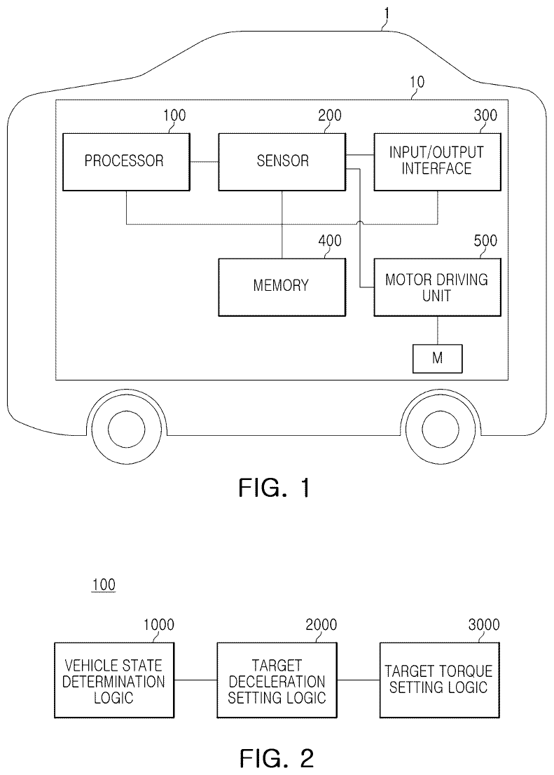

FIG. 1 is a diagram illustrating an apparatus for controlling smart regenerative braking according to an exemplary embodiment of the present disclosure.

Referring to FIG. 1, an apparatus 10 for controlling smart regenerative braking according to an exemplary embodiment of the present disclosure may include a processor 100, a sensor 200, an input/output interface 300, and a memory 400, and may be mounted on a vehicle 1.

The processor 100 may perform an operation of controlling smart regenerative braking by executing an instruction stored in the memory 400, as described below.

For example, the processor 100 may execute one or more programs stored in the memory 400. The one or more programs may include one or more computer-executable instructions, and when the computer-executable instructions are executed by the processor 100, the apparatus 10 for controlling smart regenerative braking may be configured to perform operations according to the exemplary embodiment described below.

The sensor 200 may be electrically connected to the processor 100. For example, the sensor 200 may be at least one of a steering angle sensor, a wheel speed sensor, an acceleration sensor, and a yaw rate sensor, but is not limited to the sensors in the example.

The input/output interface 300 may be electrically connected to the processor 100. For example, the input/output interface 300 may be connected to a navigation device, an input/output device, a communication module, another device, or another controller.

In exemplary embodiments of the present disclosure, the navigation device may be connected to the processor 100 through the input/output interface 300 and may provide navigation information, such as map information, state information, information related to whether the road being driven is a curved road, and the radius of curvature on a curved road, to the processor 100.

In exemplary embodiments of the present disclosure, the input/output device may be connected to other components of the apparatus 10 for controlling smart regenerative braking through the input/output interface 300. For example, the input/output device may be configured to input information from the vehicle and/or configured to output information, and may include, for example, an input device such as a pointing device (such as a mouse or a trackpad), a keyboard, a touch input device (such as a touchpad or a touchscreen), a voice or sound input device, various types of sensor devices, and/or imaging devices, and/or an output device such as a display device, a printer, a speaker, and/or a network card.

In exemplary embodiments of the present disclosure, the communication may be a cellular communication, such as one of global system for mobile communications (GSM), enhanced data rates for GSM evolution (EDGE), general packet radio service (GPRS), Code Division Multiple Access (CDMA), time division-CDMA (TD-CDMA), Universal Mobile Telecommunications System (UMTS), Long Term Evolution (LTE), or any other cellular network, but an exemplary embodiment thereof is not limited thereto.

In exemplary embodiments of the present disclosure, the other controller may be a vehicle control unit (VCU), an electronic control unit (ECU), a battery management system (BMS), or a transmission control unit (TCU), but an exemplary embodiment thereof is not limited thereto.

The memory 400 may be connected to the processor 100 and may store instructions. For example, the memory 400 may be a computer-readable storage medium and may be configured to store computer-executable instructions or program code, program data, and/or other suitable forms of information. A program stored in memory 400 may include a set of instructions executable by the processor 100.

In exemplary embodiments of the present disclosure, the memory 400 may be a volatile memory, such as a random access memory, a nonvolatile memory, or a suitable combination thereof, one or more magnetic disk storage devices, optical disk storage devices, flash memory devices, or other types of storage media which may be accessed by the apparatus 10 for controlling smart regenerative braking and may store desired information, or a suitable combination thereof.

The apparatus 10 for controlling smart regenerative braking may be connected to a motor driving unit 500 for driving the motor M, and may be configured for controlling regenerative braking for the motor M through the motor driving unit 500 according to torque distribution as described above.

As for each drawing in an example embodiment, unnecessary redundant descriptions of components with the same symbol and the same function may not be provided, and differences between the drawings may be described.

FIG. 2 is a diagram illustrating a configuration of logic performed in the processor according to an exemplary embodiment of the present disclosure.

Referring to FIG. 2, when an instruction stored in the memory 400 is executed by the processor 100, the processor 100 may perform a vehicle state determination logic 1000, a target deceleration setting logic 2000, and a target torque setting logic 3000.

In an exemplary embodiment of the present disclosure, the vehicle state determination logic 1000, the target deceleration setting logic 2000, and the target torque setting logic 3000 may be implemented by individual processor or by a single processor.

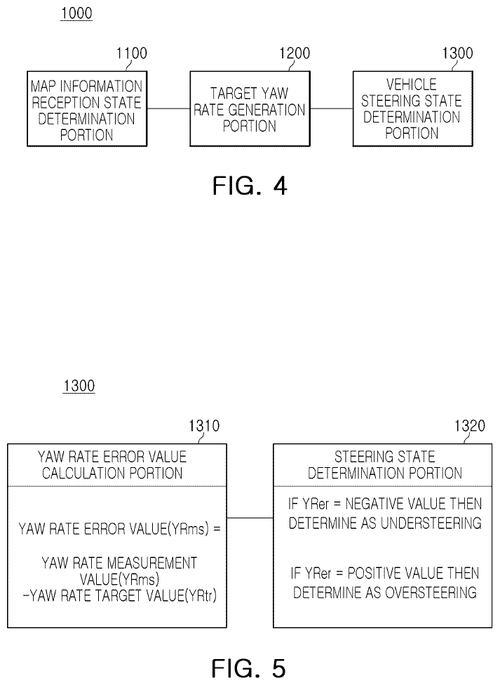

The vehicle state determination logic 1000 may be configured to determine a map information reception state and a vehicle steering state based on vehicle driving information and a yaw rate measurement value YRms obtained through the sensor 200 and the input/output interface 300, which will be described in greater detail with reference to FIG. 4 and FIG. 5.

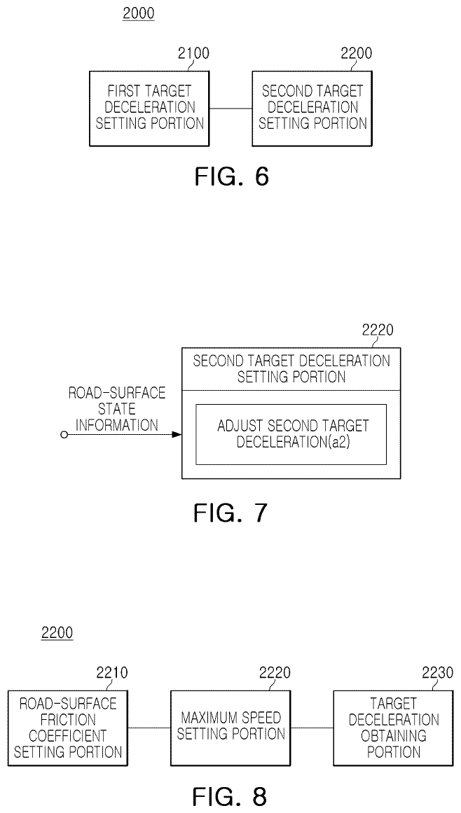

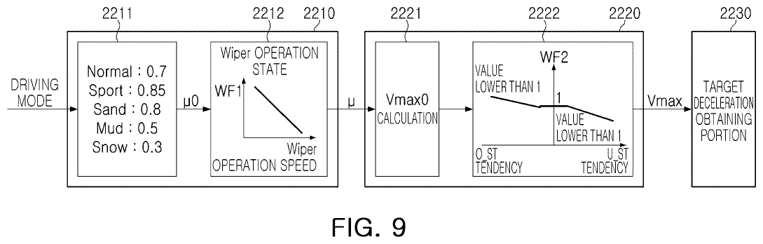

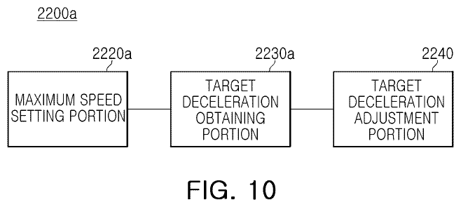

The target deceleration setting logic 2000 may obtain a first target deceleration a1 based on a distance between vehicles or a second target deceleration a2 based on map information using at least one of the map information, vehicle driving information, and yaw rate measurement value YRms depending on whether the map information is receivable, which will be described in greater detail with reference to FIG. 6, FIG. 7, FIG. 8, FIG. 9 and FIG. 10.

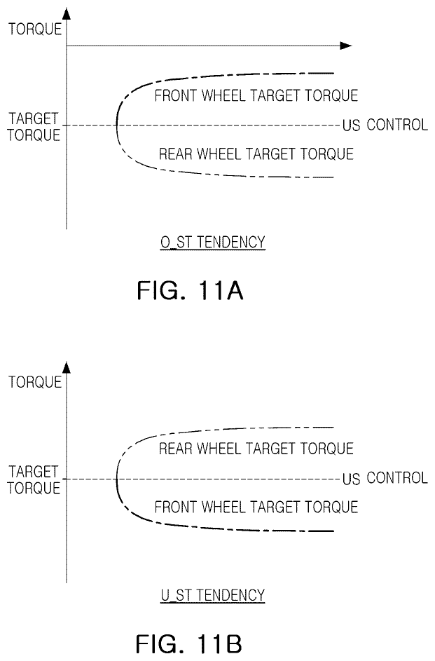

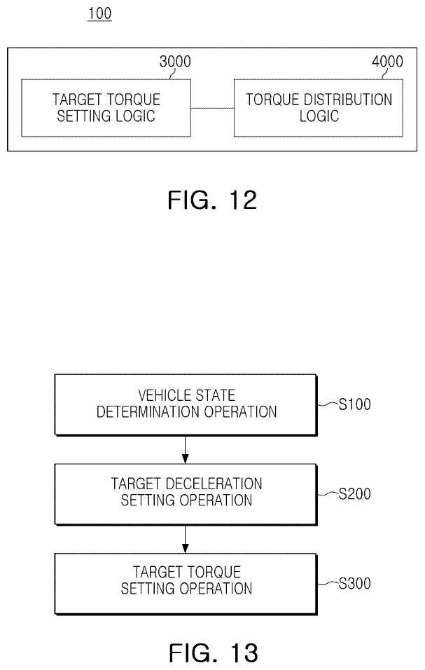

The target torque setting logic 3000 may be configured to determine a smaller value between the first target deceleration a1 and the second target deceleration a2 and may set the smaller value as target deceleration a, and may obtain and set a target torque for regenerative braking based on the target deceleration a, which will be described in greater detail with reference to FIG. 11 and FIG. 12.

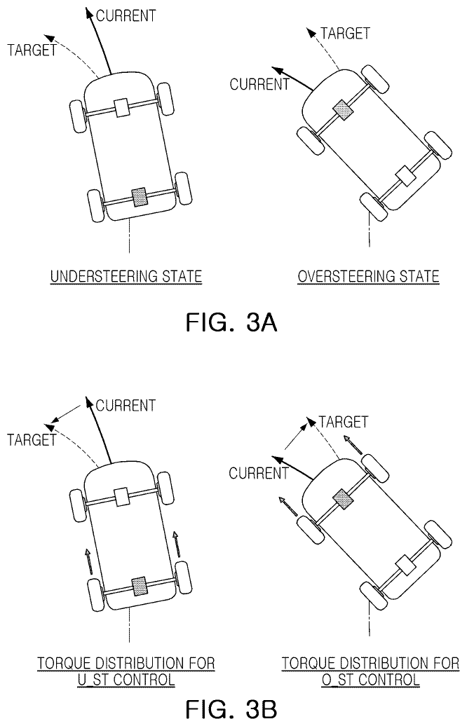

Also, the processor 100 may perform the torque distribution logic (4000, FIG. 12), and the torque distribution logic (4000, FIG. 12) may distribute the target torque to front wheels and rear wheels to correct a vehicle steering state based on the vehicle steering state, which will be described in greater detail with reference to FIGS. 3 and 12 to 12.

FIG. 3A is a diagram illustrating an understeering state and an oversteering state of a vehicle according to an exemplary embodiment of the present disclosure. FIG. 3B is a diagram illustrating torque distribution for understeering control and oversteering control according to an exemplary embodiment of the present disclosure.

Referring to FIG. 3A, when current steering of the vehicle on a curved road is less than target steering, the vehicle may be in an understeering state (see the left drawing in FIG. 3A), and conversely, when current steering of the vehicle on a curved road exceeds the target steering, the vehicle may be in an oversteering state (see the right drawing in FIG. 3A

Referring to FIG. 3B, the torque distribution logic (4000, FIG. 10) may distribute the target torque to the front wheels and the rear wheels to correct a vehicle steering state based on the vehicle steering state.

For example, as illustrated in the left drawing in FIG. 3A, when the vehicle is in an understeering state, relatively more torque may be distributed to the rear wheels compared to the front wheels as illustrated in the left drawing in FIG. 3B. Alternatively, as illustrated in the right drawing in FIG. 3A, when the vehicle is in an oversteering state, torque may be distributed relatively more to the front wheels than to the rear wheels as illustrated in the right drawing in FIG. 3B.

By controlling torque distribution according to a vehicle steering state as described above, vehicle driving stability may be improved.

FIG. 4 is a diagram illustrating a configuration of vehicle state determination logic according to an exemplary embodiment of the present disclosure.

Referring to FIG. 4, the vehicle state determination logic 1000 may include a map information reception state determination portion 1100, a target yaw rate generation portion 1200, and a vehicle steering state determination portion 1300.

The map information reception state determination portion 1100 may determine, based on the vehicle driving information, whether a first condition of whether the current braking mode is a smart regenerative braking SRS mode and whether the accelerator pedal is turned-off state, a second condition of whether the current travelling road is a curved road, and also, a third condition of whether the map information is receivable are satisfied.

For example, when the entirety of the third conditions are satisfied, an operation of setting a target deceleration based on map information may be performed, and when the first condition and the second condition are satisfied and the third condition is not satisfied, an operation of setting a target deceleration based on a distance between vehicles may be performed.

The target yaw rate generation portion 1200 may be configured to generate the yaw rate target value YRtr based on the yaw rate measurement value YRms. For example, the steering angle, wheel speed, acceleration and yaw rate measurement value YRms may be received, and the yaw rate target value YRtr for the vehicle being driven based on a generally known bicycle model may be generated.

The vehicle steering state determination portion 1300 may be configured to determine whether the vehicle steering state is an understeering U_ST state or an oversteering O_ST state based on the yaw rate measurement value YRms, the yaw rate target value YRtr and the yaw rate error value YRer. For example, when the yaw rate error value YRer is negative, the state may be determined as understeering U_ST, and when the yaw rate error value YRer is positive, the state may be determined as oversteering O_ST, which will be described in greater detail with reference to FIG. 5.

FIG. 5 is a diagram illustrating a configuration of vehicle steering state determination portion according to an exemplary embodiment of the present disclosure.

Referring to FIG. 5, the vehicle steering state determination portion 1300 may include a yaw rate error value calculation portion 1310, and a steering state determination portion 1320.

The yaw rate error value calculation portion 1310 may obtain a yaw rate error value YRer by subtracting the yaw rate target value YRtr from the yaw rate measurement value YRms as in equation 1 below.

$$YPer = YRms - Yrtr \qquad [ Equation 1 ]$$

The equation1 is merely an example and the present disclosure is not limited thereto. Alternatively, the yaw rate error value YRer may be obtained by subtracting the yaw rate measurement value YRms from the yaw rate target value YRtr.

The steering state determination portion 1320 may be configured to determine the state as understeering U_ST when the yaw rate error value YRer obtained together with the equation1 is negative, and may be configured to determine the state as oversteering O_ST when the yaw rate error value YRer is positive.

FIG. 6 is a diagram illustrating a configuration of target deceleration setting logic 2000 according to an exemplary embodiment of the present disclosure.

Referring to FIG. 6, a target deceleration setting logic 2000 may include a first target deceleration setting portion 2100 and a second target deceleration setting portion 2200.

The first target deceleration setting portion 2100 may adjust the initial target deceleration a0 based on the yaw rate error value YRer when the map information may not be received, obtaining the first target deceleration a1.

For example, the initial target deceleration a0 may be obtained based on the distance between vehicles. The yaw rate error value YRer may be reflected in the initial target deceleration a0 and the first target deceleration a1 may be obtained. For example, the first target deceleration a1 may be obtained by multiplying the initial target deceleration a0 by the yaw rate error value YRer.

The second target deceleration setting portion 2200 may adjust the initial target deceleration a0 based on the radius of curvature, driving mode, wiper operation information and yaw rate error value YRer included in the map information when the map information is receivable, and may obtain the second target deceleration a2.

For example, the maximum speed Vmax may be obtained based on the radius of curvature, driving mode, wiper operation information and yaw rate error value YRer, and the second target deceleration a2 may be obtained based on the error speed between the current vehicle speed and the target speed, which is the maximum speed Vmax, and a predetermined setting time, which will be described in greater detail with reference to FIG. 9.

FIG. 7 is a diagram illustrating a second target deceleration setting portion according to an exemplary embodiment of the present disclosure.

Referring to FIG. 7, for example, the second target deceleration setting portion 2200 may adjust the second target deceleration a2 more precisely by reflecting the road-surface state information when the vehicle driving information includes road-surface state information.

For example, when road surface information (e.g., snowy road, asphalt, or the like) is further input through the vehicle camera, the second target deceleration a2 may be adjusted more precisely using the present road surface information. For example, in the case of snowy road, the second target deceleration a2 may be lowered by a predetermined value, and in the case of asphalt, the second target deceleration a2 may be slightly raised by a predetermined value.

FIG. 8 is a diagram illustrating a configuration of a second target deceleration setting portion according to an exemplary embodiment of the present disclosure.

Referring to FIG. 8, the second target deceleration setting portion 2200 may include a road-surface friction coefficient setting portion 2210, a maximum speed setting portion 2220, and a target deceleration obtaining portion 2230.

The road-surface friction coefficient setting portion 2210 may set different initial road-surface friction coefficient μ0 depending on a driving mode included in the vehicle driving information, and by applying a first weighting factor WF1 according to the wiper operation state to the initial road-surface friction coefficient μ0, a final road-surface friction coefficient μ may be obtained.

The maximum speed setting portion 2220 may obtain the initial maximum speed Vmax0 using the final road-surface friction coefficient μ, the radius of curvature r included in the map information, and the gravitational acceleration g, and may obtain the final maximum speed Vmax by applying the second weighting factor WF2 based on the yaw rate error value YRer to the initial maximum speed Vmax0.

The target deceleration obtaining portion 2230 may obtain the second target deceleration a2 based on the final maximum speed Vmax and the measured current speed Vmes, which will be described in greater detail with reference to FIG. 9.

FIG. 9 is a diagram illustrating a configuration of a second target deceleration setting portion according to an exemplary embodiment of the present disclosure.

Referring to FIG. 9, for example, a road-surface friction coefficient setting portion 2210 may include a road-surface friction coefficient setting portion 2211 and a first weight setting portion 2212.

The road-surface friction coefficient setting portion 2211 may set different initial road-surface friction coefficient μ0 depending on a driving mode included in the vehicle driving information. For example, the initial road-surface friction coefficient μ0 may be set to 0.7, 0.85, 0.8, 0.5, and 0.3 for the driving mode of normal, sport, stand, mud, and snow, respectively. These examples are provided for ease of description, and the present disclosure is not limited thereto.

The first weight setting portion 2212 may obtain the final road-surface friction coefficient μ by applying the first weighting factor WF1 in accordance with the wiper operation state to the initial road-surface friction coefficient μ0. For example, the coefficient may be described to be inversely proportional to the wiper operation speed.

For example, when the wiper operation speed is an average speed, the first weighting factor WF1 is set to ‘1’, and the wiper operation speed is lower than the average, the first weighting factor WF1 may be set to a value greater than ‘1’ in proportion to the wiper operation speed, and conversely, when the wiper operation speed is higher than the average, the first weighting factor WF1 may be set to a value less than ‘1’ in proportion to the wiper operation speed.

The maximum speed setting portion 2220 may include an initial maximum speed calculation portion 2221 and a final maximum speed calculation portion 2222.

The initial maximum speed calculation portion 2221 may obtain the initial maximum speed Vmax0 as in equation 2 below using the final road-surface friction coefficient μ, the radius of curvature r included in the map information, and the gravitational acceleration g.

$$V max 0 = {( r * g * μ )}^{⋀} 0.5 \qquad [ Equation 2 ]$$

The final maximum speed calculation portion 2222 may obtain the final maximum speed Vmax by applying the second weighting factor WF2 based on the yaw rate error value YRer to the initial maximum speed Vmax0 as indicated in equation 3.

$$V max = [ {( r * g * μ )}^{⋀} 0.5 ] * WF 2 \qquad [ Equation 3 ]$$

The second target deceleration setting portion 2200 may adjust the target deceleration by setting different initial road-surface friction coefficients μ0 depending on the driving mode included in the vehicle driving information. Alternatively, instead of setting the initial road-surface friction coefficient μ0 according to the driving mode, the road-surface friction coefficient μ may be set to a fixed value, the target deceleration may be determined, and a weight based on the yaw rate may be applied to the target deceleration, obtaining the final target deceleration, which will be described with reference to FIG. 10.

FIG. 10 is a diagram illustrating a configuration of a second target deceleration setting portion according to an exemplary embodiment of the present disclosure.

Referring to FIG. 10, a second target deceleration setting portion 2200a may include a maximum speed setting portion 2220a, a target deceleration obtaining portion 2230a, and a target deceleration adjustment portion 2240.

The maximum speed setting portion 2220a may obtain the initial maximum speed Vmax0 using the initial road-surface friction coefficient μ0, the radius of curvature r included in the map information, and the gravitational acceleration g, and may obtain the final maximum speed Vmax by applying the second weighting factor WF2 based on the yaw rate error value YRer to the initial maximum speed Vmax0.

The target deceleration obtaining portion 2230a may obtain the second target deceleration a2 based on the final maximum speed Vmax and the measured current speed Vmes. For example, the second target deceleration a2 may be obtained using the speed error value (Ver=Vmax-Vmes) and the predetermined time period, which are the results of subtracting the measured current speed Vmes from the final maximum speed Vmax.

The target deceleration adjustment portion 2240 may adjust the second target deceleration a2 using the yaw rate error value YRer.

FIG. 11A is a diagram illustrating torque distribution in the case of in the case of oversteering O_ST according to an exemplary embodiment of the present disclosure. FIG. 11B is a diagram illustrating torque distribution in the case of understeering U_ST according to an exemplary embodiment of the present disclosure.

Referring to FIG. 11A, a target torque setting logic 3000 may set the target torque to be distributed more to front wheels than to rear wheels by a set ratio when the vehicle steering state is an oversteering O_ST state.

Referring to FIG. 11B, the target torque to be distributed more to the rear wheels than to the front wheels by a set ratio when the vehicle steering state is an understeering U_ST state.

FIG. 12 is a diagram illustrating a torque distribution logic according to an exemplary embodiment of the present disclosure.

Referring to FIG. 12, the yaw rate-based smart regenerative braking control device 10 in an exemplary embodiment of the present disclosure may further include a torque distribution logic 4000.

For example, when the current vehicle driving of the vehicle driving information is a four-wheel driving mode, the torque distribution logic 4000 may distribute motor torque to front wheels and rear wheels according to the torque distribution setting.

For example, as illustrated in the left drawing in FIG. 3A, in the case of an understeering state, more torque may be distributed to the rear wheels relatively than to the front wheel as illustrated in the left drawing in FIG. 3B. Alternatively, as illustrated in the right drawing in FIG. 3A, in the case of an oversteering state, more torque may be distributed to the front wheels relatively than to the rear wheel as illustrated in the right drawing in FIG. 3B. As described above, by receiving feedback on the current vehicle steering state, the vehicle steering state may be corrected, and accordingly, the vehicle driving stability may be improved.

In contrast, the torque distribution logic 4000 may suggest to a user through the screen display whether to change to and engage in 4WD driving mode for front/rear motor torque distribution when the current vehicle is in 2WD mode.

Hereinafter, referring to FIGS. 13 to 21, a method for controlling smart regenerative braking control may be described. In exemplary embodiments of the present disclosure, the description of the method for controlling smart regenerative braking control and the description of the apparatus for controlling smart regenerative braking may be applied complementarily or in common, unless otherwise indicated. Accordingly, overlapping descriptions may not be provided. Hereinafter, main processes of the method for controlling smart regenerative braking control may be described.

FIG. 13 is a flowchart illustrating a method for controlling smart regenerative braking control according to an exemplary embodiment of the present disclosure.

Referring to FIGS. 1 and 13, the method for controlling smart regenerative braking control according to an exemplary embodiment of the present disclosure may be performed by, for example, an apparatus for controlling smart regenerative braking (see FIG. 1, 10).

The method for controlling smart regenerative braking control in an exemplary embodiment of the present disclosure may include a vehicle state determination operation S100, a target deceleration setting operation S200, and a target torque setting operation S300.

In the vehicle state determination operation S100, the apparatus for controlling smart regenerative braking (see FIG. 1, 10) may be configured to determine a map information reception state and a vehicle steering state based on vehicle driving information and a yaw rate measurement value YRms obtained through a sensor 200 and an input/output interface 300.

In the target deceleration setting operation S200, the apparatus for controlling smart regenerative braking (10, see FIG. 1) may obtain and set a first target deceleration a1 based on a distance between vehicles or a second target deceleration a2 based on map information using at least one of map information, vehicle driving information, and yaw rate measurement value YRms depending on whether the map information is receivable.

In the target torque setting operation S300, the apparatus for controlling smart regenerative braking (10, see FIG. 1) may be configured to determine a smaller value among the first target deceleration a1 and the second target deceleration a2 as target deceleration a, and may obtain and set a target torque for regenerative braking based on the target deceleration a.

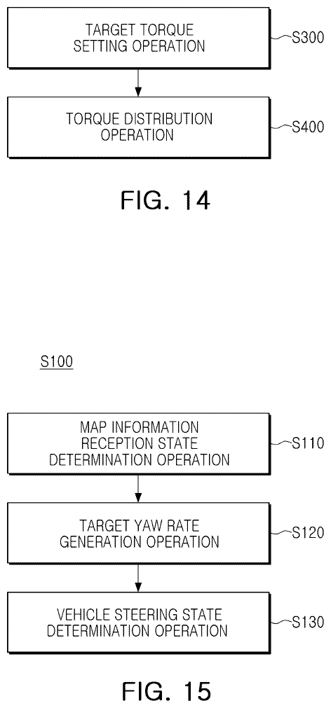

FIG. 14 is a diagram illustrating a torque distribution operation according to an exemplary embodiment of the present disclosure.

Referring to FIG. 14, a method for controlling smart regenerative braking control in an exemplary embodiment of the present disclosure may further include a torque distribution operation S400.

For example, in the torque distribution operation S400, the apparatus for controlling smart regenerative braking (10, see FIG. 1) may distribute the target torque to front wheels and rear wheels to correct a vehicle steering state based on the vehicle steering state.

FIG. 15 is a diagram illustrating a vehicle state determination operation according to an exemplary embodiment of the present disclosure.

Referring to FIG. 15, the vehicle state determination operation S100 may include a map information reception state determination operation S110, a target yaw rate generation operation S120, and a vehicle steering state determination operation S130.

In the map information reception state determination operation S110, the apparatus for controlling smart regenerative braking (10, see FIG. 1) may determine, based on the vehicle driving information, whether a first condition of whether a current braking mode is a smart regenerative braking SRS mode and whether an accelerator pedal is in a turned-off state, a second condition of whether a current travelling road is a curved road, and also, a third condition of whether the map information is receivable are satisfied.

For example, when the entirety of the third conditions are satisfied, an operation of setting a target deceleration based on map information may be performed, and when the first condition and the second condition are satisfied and the third condition is not satisfied, an operation of setting a target deceleration based on a distance between vehicles may be performed.

In the target yaw rate generation operation S120, the apparatus for controlling smart regenerative braking (10, see FIG. 1) may be configured to generate a yaw rate target value YRtr based on the yaw rate measurement value YRms.

In the vehicle steering state determination operation S130, the apparatus for controlling smart regenerative braking (10, see FIG. 1) may be configured to determine whether the vehicle steering state is an understeering U_ST state or an oversteering O_ST state based on a yaw rate error value YRer between the yaw rate measurement value YRms and the yaw rate target value YRtr.

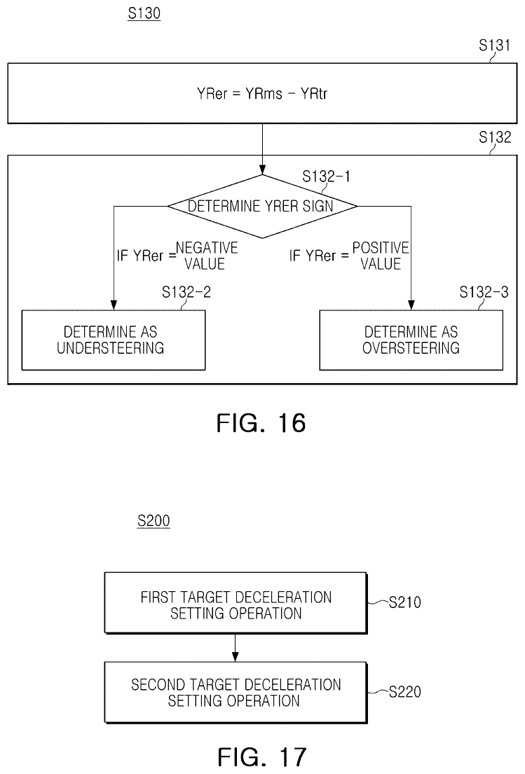

FIG. 16 is a diagram illustrating a configuration of a vehicle steering state determination operation according to an exemplary embodiment of the present disclosure.

Referring to FIG. 16, the vehicle steering state determination operation S130 may include a yaw rate error value determination operation S131 and a steering state determination operation S132.

In the yaw rate error value determination operation S131, the apparatus for controlling smart regenerative braking (10, see FIG. 1) may obtain a yaw rate error value YRer by subtracting the yaw rate target value YRtr from the yaw rate measurement value YRms.

In the steering state determination operation S132, the apparatus for controlling smart regenerative braking (10, see FIG. 1) may be configured to determine the state as understeering U_ST when the yaw rate error value YRer is negative, and may be configured to determine the state as oversteering O_ST when the yaw rate error value YRer is positive.

FIG. 17 is a diagram illustrating a configuration of a target deceleration setting operation according to an exemplary embodiment of the present disclosure.

Referring to FIG. 17, a target deceleration setting operation S200 may include a first target deceleration setting operation S210 and a second target deceleration setting operation S220.

In the first target deceleration setting operation S210, the apparatus for controlling smart regenerative braking (10, see FIG. 1) may adjust initial target deceleration a0 based on the yaw rate error value YRer, obtaining the first target deceleration a1 when the map information may not be received.

In the second target deceleration setting operation S220, the apparatus for controlling smart regenerative braking (10, see FIG. 1) may obtain second target deceleration a2 by adjusting the initial target deceleration a0 based on the radius of curvature, driving mode, wiper operation information and yaw rate error value YRer included in the map information when the map information is receivable.

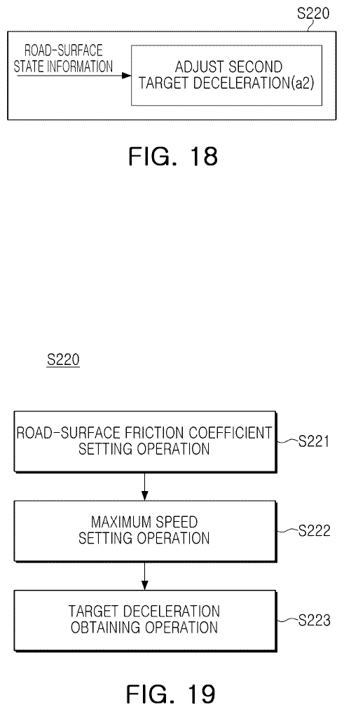

FIG. 18 is a diagram illustrating a second target deceleration setting operation according to an exemplary embodiment of the present disclosure.

Referring to FIG. 18, the second target deceleration setting operation S220 may adjust the second target deceleration a2 by reflecting road-surface state information when the vehicle driving information may include the road-surface state information.

As described above, for example, when additional road surface information (e.g., snow, asphalt, or the like) is input through the vehicle camera, the second target deceleration a2 may be adjusted more precisely using the road surface information.

FIG. 19 is a diagram illustrating a configuration of a second target deceleration setting operation according to an exemplary embodiment of the present disclosure.

Referring to FIG. 19, the second target deceleration setting operation S220 may include a road-surface friction coefficient setting operation S221, a maximum speed setting operation S222, and a target deceleration obtaining operation S223.

In the road-surface friction coefficient setting operation S221, the apparatus for controlling smart regenerative braking (10, see FIG. 1) may set different initial road-surface friction coefficients μ0 depending on a driving mode included in the vehicle driving information, and may apply a first weighting factor WF1 according to the wiper operation state to the initial road-surface friction coefficient μ0, obtaining a final road-surface friction coefficient μ.

In the maximum speed setting operation S222, the apparatus for controlling smart regenerative braking (10, see FIG. 1) may obtain the initial maximum speed Vmax0 using the final road-surface friction coefficient μ, the radius of curvature r included in the map information, and the gravitational acceleration g, and may obtain the final maximum speed Vmax by applying the second weighting factor WF2 based on the yaw rate error value YRer to the initial maximum speed Vmax0.

In the target deceleration obtaining operation S223, the apparatus for controlling smart regenerative braking (10, see FIG. 1) may obtain the second target deceleration a2 based on the final maximum speed Vmax and the measured current speed Vmes.

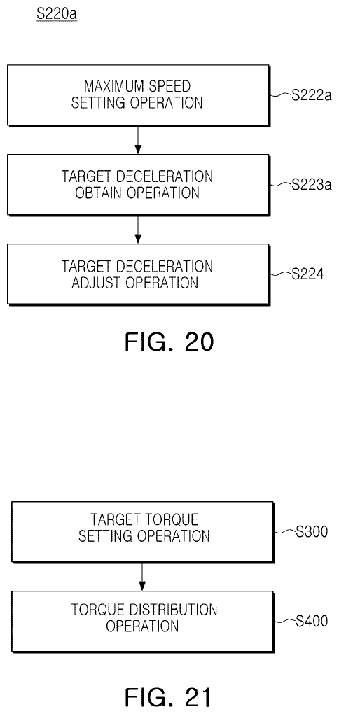

FIG. 20 is a diagram illustrating a configuration of a second target deceleration setting operation according to an exemplary embodiment of the present disclosure.

Referring to FIG. 20, a second target deceleration setting operation S220a may include a maximum speed setting operation S222a, a target deceleration obtain operation S223a, and a target deceleration adjust operation S224.

In the maximum speed setting operation S222a, the apparatus for controlling smart regenerative braking (10, see FIG. 1) may obtain the initial maximum speed Vmax0 using the initial road-surface friction coefficient μ0, the radius of curvature r included in the map information, and the gravitational acceleration g, and may obtain the final maximum speed Vmax by applying the second weighting factor WF2 based on the yaw rate error value YRer to the initial maximum speed Vmax0.

In the target deceleration obtaining operation S223a, the apparatus for controlling smart regenerative braking (10, see FIG. 1) may obtain the second target deceleration a2 based on the final maximum speed Vmax and the measured current speed Vmes.

In the target deceleration adjust operation S224, the apparatus for controlling smart regenerative braking (10, see FIG. 1) may adjust the second target deceleration a2 using the yaw rate error value YRer.

Also, in the target torque setting operation S300, the apparatus for controlling smart regenerative braking (10, see FIG. 1) may distribute the target torque to the front wheels more than the rear wheels by a set ratio when the vehicle steering state is an oversteering O_ST state.

Optionally, the apparatus for controlling smart regenerative braking (10, see FIG. 1) may distribute the target torque to the rear wheels more than the front wheels by a set ratio when the vehicle steering state is an understeering U_ST state.

FIG. 21 is a diagram illustrating a torque distribution operation according to an exemplary embodiment of the present disclosure.

Referring to FIG. 21, in the torque distribution operation S400, the apparatus for controlling smart regenerative braking (10, see FIG. 1) may distribute motor torque for front wheels and rear wheels according to the torque distribution setting when the current vehicle driving of the vehicle driving information is 4-wheel driving mode, and may suggest changing to or engaging in the 4WD driving mode for the front/rear motor torque distribution when the current vehicle driving is a 2-wheel driving 2WD mode.

According to the aforementioned embodiments, by reflecting the driving condition of a vehicle based on yaw rate and navigation information into the target deceleration setting and torque distribution strategy, unnecessary deceleration may be prevented, unnecessary driver intervention may be reduced, and accordingly, the effect of improving vehicle driving stability may be provided.

In other words, by receiving feedback on the vehicle steering state (understeering or oversteering) and applying the feedback to the target deceleration determination and torque distribution, grip force of the tire may be improved, and driving stability may be improved.

Also, relatively excessive deceleration may be prevented, and unnecessary deceleration may be reduced by reducing the number of driver interventions so that driving incongruity may be improved.

Also, by applying the vehicle steering state (understeering or oversteering) to the torque distribution, the vehicle posture control may be improved preemptively, and intervention frequency of the braking control may be reduced by delaying intervention of electronic stability control (ESC) or roll stability control (RSC) control as much as possible, contributing to improvement of brake pad life and stability for a driver.

The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the FIGURES. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling smart regenerative braking based on yaw rate, the apparatus comprising:
a processor;
a sensor electrically connected to the processor;
an input/output interface electrically connected to the processor; and
a memory connected to the processor and storing instructions,
wherein, based on that an instruction stored in the memory is executed by the processor, the processor is configured to perform a vehicle state determination logic configured to determine a map information reception state and a vehicle steering state based on vehicle driving information and a yaw rate measurement value obtained through the sensor and the input/output interface,
the processor is configured to perform a target deceleration setting logic configured to obtain a first target deceleration based on a distance between vehicles or a second target deceleration based on map information using at least one of the map information, the vehicle driving information, and the yaw rate measurement value depending on whether the map information is receivable, and
the processor is further configured to perform a target torque setting logic configured to determine a smaller value between the first target deceleration and the second target deceleration and set the smaller value as target deceleration, and determining target torque for regenerative braking based on the target deceleration.

2. The apparatus of claim 1, wherein the processor is further configured to perform a torque distribution logic configured to distribute the target torque to front and rear wheels to correct a vehicle steering state based on the vehicle steering state.

3. The apparatus of claim 2, wherein the vehicle state determination logic includes:
a map information reception state determination portion configured to determine whether an entirety of a first condition of whether current braking mode is a smart regenerative braking mode and whether an accelerator pedal is in a turned-off state, a second condition of whether a current travelling road is a curved road, and a third condition of whether the map information is receivable are satisfied based on the vehicle driving information;
a target yaw rate generation portion configured to generate a yaw rate target value based on the yaw rate measurement value; and
a vehicle steering state determination portion configured to determine whether the vehicle steering state is an understeering state or an oversteering state based on a yaw rate error value between the yaw rate measurement value and the yaw rate target value.

4. The apparatus of claim 3, wherein the vehicle steering state determination portion includes:
a yaw rate error value calculation portion configured to obtain the yaw rate error value by subtracting the yaw rate target value from the yaw rate measurement value; and
a steering state determination portion configured to determine a state as the understeering state based on that the yaw rate error value is negative, and to determine a state as the oversteering state based on that the yaw rate error value is positive.

5. The apparatus of claim 4, wherein the target deceleration setting logic includes:
a first target deceleration setting portion configured to adjust an initial target deceleration based on the yaw rate error value and to obtain the first target deceleration based on that the map information is unreceivable; and
a second target deceleration setting portion configured to adjust the initial target deceleration based on a radius of curvature, driving mode, wiper operation information and yaw rate error value included in the map information and to obtain the second target deceleration based on that the map information is receivable.

6. The apparatus of claim 5, wherein the second target deceleration setting portion is configured to adjust the second target deceleration by reflecting the road-surface state information based on that road-surface state information is included in the vehicle driving information.

7. The apparatus of claim 5, wherein the second target deceleration setting portion includes:
a road-surface friction coefficient setting portion configured to set different initial road-surface friction coefficients in accordance with a driving mode included in the vehicle driving information, and to obtain a final road-surface friction coefficient by applying a first weighting factor in accordance with a wiper operation state to an initial road-surface friction coefficient;
a maximum speed setting portion configured to determine an initial maximum speed using the final road-surface friction coefficient, a radius of curvature included in the map information, and gravitational acceleration, and to determine a final maximum speed by applying a second weighting factor based on the yaw rate error value to the initial maximum speed; and
a target deceleration obtaining portion configured to obtain the second target deceleration based on the final maximum speed and measured current speed.

8. The apparatus of claim 5, wherein the second target deceleration setting portion includes:
a maximum speed setting portion configured to obtain an initial maximum speed using an initial road-surface friction coefficient, the radius of curvature included in the map information, and gravitational acceleration, and to obtain a final maximum speed by applying a second weighting factor based on the yaw rate error value to the initial maximum speed;
a target deceleration obtaining portion configured to obtain the second target deceleration based on the final maximum speed and measured current speed; and
a target deceleration adjustment portion configured to adjust the second target deceleration using the yaw rate error value.

9. The apparatus of claim 5, wherein the target torque setting logic sets the target torque to be distributed more to the front wheels than to the rear wheels by a set ratio based on that the vehicle steering state is the oversteering state, and sets the target torque to be distributed more to the rear wheels than to the front wheels by a set ratio based on that the vehicle steering state is the understeering state.

10. The apparatus of claim 9, wherein the processor is further configured to perform:
a torque distribution logic configured to distribute motor torque to the front and rear wheels in accordance with the torque distribution setting based on that current vehicle driving of the vehicle driving information is in 4-wheel driving mode, and suggests changing to or engagement in 4WD driving mode for front/rear motor torque distribution based on that the current vehicle driving is in 2WD driving mode.

11. A method for controlling, by a processor, smart regenerative braking control based on yaw rate, the method comprising:
a vehicle state determination operation of determining a map information reception state and a vehicle steering state based on vehicle driving information and a yaw rate measurement value obtained through a sensor and an input/output interface electrically connected to the processor;
a target deceleration setting operation of obtaining and setting a first target deceleration based on a distance between vehicles or a second target deceleration based on map information using at least one of the map information, the vehicle driving information, and the yaw rate measurement value depending on whether the map information is receivable; and
a target torque setting operation of determining a smaller value among the first target deceleration and the second target deceleration as target deceleration, and obtaining and setting a target torque for regenerative braking based on the target deceleration.

12. The method of claim 11, further including:
a torque distribution operation of distributing the target torque to front and rear wheels to correct the vehicle steering state based on the vehicle steering state.

13. The method of claim 12, wherein the vehicle state determination operation includes:
a map information reception state determination operation of determining whether an entirety of a first condition of whether a current braking mode is a smart regenerative braking mode and whether an accelerator pedal is in a turned-off state, a second condition of whether a current travelling road is a curved road, and a third condition of whether the map information is receivable are satisfied based on the vehicle driving information;
a target yaw rate generation operation of generating a yaw rate target value based on the yaw rate measurement value; and
a vehicle steering state determination operation of determining whether the vehicle steering state is an understeering state or an oversteering state based on a yaw rate error value between the yaw rate measurement value and the yaw rate target value.

14. The method of claim 13, wherein the vehicle steering state determination operation includes:
a yaw rate error value determination operation of obtaining the yaw rate error value by subtracting the yaw rate target value from the yaw rate measurement value; and
a steering state determination operation of determining the understeering state based on that the yaw rate error value is negative, and determining the oversteering state based on that the yaw rate error value is positive.

15. The method of claim 13, wherein the target deceleration setting operation includes:
a first target deceleration setting operation of obtaining and setting first target deceleration by adjusting initial target deceleration based on the yaw rate error value based on that the map information is unreceivable;
a second target deceleration setting operation of obtaining and setting second target deceleration by adjusting the initial target deceleration based on a radius of curvature, driving mode, wiper operation information and yaw rate error value included in the map information based on that the map information is receivable.

16. The method of claim 15, wherein the second target deceleration setting operation includes adjusting the second target deceleration by reflecting road-surface state information based on that the road-surface state information is included in the vehicle driving information.

17. The method of claim 15, wherein the second target deceleration setting operation includes:
a road-surface friction coefficient setting operation of setting different initial road-surface friction coefficients in accordance with a driving mode included in the vehicle driving information, and obtaining a final road-surface friction coefficient by applying a first weighting factor in accordance with a wiper operation state to an initial road-surface friction coefficient;
a maximum speed setting operation of determining an initial maximum speed using the final road-surface friction coefficient, the radius of curvature included in the map information, and gravitational acceleration, and determining a final maximum speed by applying a second weighting factor based on the yaw rate error value to the initial maximum speed; and
a target deceleration obtain operation of obtaining the second target deceleration based on the final maximum speed and measured current speed.

18. The method of claim 15, wherein the second target deceleration setting operation includes:
a maximum speed setting operation of determining an initial maximum speed using an initial road-surface friction coefficient, the radius of curvature included in the map information, and gravitational acceleration, and determining a final maximum speed by applying a second weighting factor based on the yaw rate error value to the initial maximum speed;
a target deceleration obtain operation of obtaining the second target deceleration based on the final maximum speed and measured current speed; and
a target deceleration adjust operation of adjusting the second target deceleration using the yaw rate error value.

19. The method of claim 15, wherein the target torque setting operation includes:
setting the target torque to be distributed more to the front wheels than to the rear wheels by a set ratio based on that the vehicle steering state is the oversteering state, and
setting the target torque to be distributed more to the rear wheels than to the front wheels by a set ratio based on that the vehicle steering state is the understeering state.

20. The method of claim 19, wherein the torque distribution operation includes distributing motor torque to the front and rear wheels in accordance with torque distribution setting based on that current vehicle driving of the vehicle driving information is in 4-wheel driving mode, and suggesting changing to or engagement in 4WD driving mode for front/rear motor torque distribution based on that the current vehicle driving is in 2-wheel driving mode.
